(19) United States
(12) Patent Application Publication
(10) Pub. No.: US 2015/0101026 A1
(43) Pub. Date: Apr. 9, 2015

(54) DEVICE, SYSTEM, AND METHOD OF SOCIAL NETWORKING

(71) Applicant: Yoram KRAUS, Moshav Mazor (IL)

(72) Inventor: Yoram KRAUS, Moshav Mazor (IL)

(21) Appl. No.: 14/501,061

(22) Filed: Sep. 30, 2014

Related U.S. Application Data
(60) Provisional application No. 61/886,096, filed on Oct. 3, 2013.

(51) Int. Cl. H04L 12/18; H04L 29/08; H04L 29/06

(52) U.S. Cl. CPC H04L 12/1813; H04L 63/08; H04L 67/22
USPC 726/4

(57) ABSTRACT

Device, system, and method of social networking and for creating and managing an online social network, which focuses on deceased persons and their remembrance and memorialization. A living person may create a memorial social network page for a deceased person; and other living users may continuously contribute content items to that memorial page on the social network. Additionally, a living person may create a personal page on the social network; the system may subsequently estimate or determine that the living person passed away, and may automatically convert the personal page into a memorial page, which may be continuously updated and augmented with content items that other users may submit with regard to the user who passed away.

### CROSS-REFERENCE TO RELATED APPLICATIONS

This application claims priority and benefit from U.S. provisional patent application No. 61/886,096, filed on Oct. 3, 2013, which is hereby incorporated by reference in its entirety.

### FIELD OF THE INVENTION

The present invention relates to the field of social networking services.

### BACKGROUND

Millions of users utilize the Internet and the World Wide Web every day, in order to read or consume web content. For example, users utilize personal computers, laptop computers, smartphones, tablets, or other electronic devices, typically including a browser, in order to read online news, watch videos, interact with other users through online chat or messaging, play games, or otherwise consume digital content.

### SUMMARY

The present invention may comprise, for example, devices, systems, and methods of social networking services; and particularly, of social networking services that are related to deceased person(s).

In accordance with some demonstrative embodiments of the present invention, for example, a device, system, and method of social networking may be provided, for creating and managing an online social network, which focuses on deceased persons and their remembrance and memorialization. For example, a living person may create a memorial social network page for a deceased person; and other living users may continuously contribute content items to that memorial page on the social network. Additionally, a living person may create a personal page on the social network; the system may subsequently estimate or determine that the living person passed away, and may automatically convert the personal page into a memorial page, which may be continuously updated and augmented with content items that other users may submit with regard to the user who passed away.

For example, a computerized method may comprise: (a) receiving a request of a primary living user to create a social networking web-page for an already-deceased person; (b) creating the social networking web-page for said already-deceased person; (c) authorizing said primary living user to upload content items to said social networking web-page of said already-deceased person, and receiving said content items uploaded by said primary living user; (d) presenting to other living users, the social networking web-page of said already-deceased person, comprising said content items uploaded by said primary living user.

The present invention may provide other and/or additional benefits or advantages.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative embodiments of the present invention; and

FIG. 2 is a schematic block-diagram illustration of a Social Networking (SN) module, in accordance with some demonstrative embodiments of the present invention.

### DETAILED DESCRIPTION OF THE PRESENT INVENTION

In the following detailed description, numerous specific details are set forth in order to provide a thorough understanding of some embodiments. However, it may be understood by persons of ordinary skill in the art that some embodiments may be practiced without these specific details. In other instances, well-known methods, procedures, components, units and/or circuits have not been described in detail so as not to obscure the discussion.

The present invention enables a computerized system to operate a social network that allows for the commemoration, remembrance and sharing with regard to deceased persons. The computerized social network enables registrants to create, modify, control and/or otherwise manage commemoration pages for their dearly departed and for people whom they wish to remember. The system enables a user to create a commemoration page on the system, and to fully or partially or selectively share the memorial data (e.g., text, photos, videos, audio clips, or the like) with some or all of the people who were close to the deceased, or with other target audience, or with the general public.

Applicants have realized that there is an unfilled need for such unique solution. A user gradually loses friends and relatives that are close or dear or important to the user, and that such loss spans both the real world and the virtual world (or digital world).

The present invention enables unique features that are not found in any conventional system or social networking services. For example, some conventional social networks (e.g., Facebook or LinkedIn) may shut-down or terminate or “freeze” the online profile of a deceased subscriber; whereas, in contrast, the system of the present invention allows and enables ongoing maintenance, updating and modification for profiles or pages that are related to deceased persons. Similarly, some social networking websites (e.g., YouTube) may delete videos and/or channels that were uploaded or created by subscribers who passed away, or may otherwise terminate their accounts and/or may delete content that used to belong to subscribers who are now deceased; whereas, in contrast, the present invention allows preservation of such content, as well as ongoing expansion and augmentation of such content, even after the passing away of the deceased person.

The present invention operates in direct contrast with current systems, which terminate or shut-down or delete or “freeze” (e.g., maintain static or un-changed) the content or profile or web-page of a subscriber who passed away. The Applicants have realized that every year, there is more and more information to remember, more people to remember and more people to miss (since friends or relatives gradually pass away), while there are no conventional options allowing the living users to remember or commemorate the deceased, as well as digital content related to the deceased.

The present invention comprises a social networking computerized system, which puts an a dominant emphasis on persons who passed away, dedicated to their memory and commemoration, as opposed to conventional social networks that are dedicated to the activities of living people. For example, Facebook focuses on social activities, personal connections and social sharing among living people, and not with relation to deceased person(s); and LinkedIn focuses on professional data regarding living people, who act and share in the business world, and not with relation to deceased person(s).

Similarly, conventional genealogy (or “roots”) websites focus on names and facts, not on emotions and sharing of personal information or memories related to the deceased. Such conventional websites do not enable the initiation of interactive activities relating to the deceased person, and do not provide any tools for such interactions. In contrast, the present invention enables interactive activities among living persons, with relation to deceased person(s): dialogue, sharing life stories, uploading photos and video clips and audio clips about the deceased person or related to the deceased person, sharing the memory and commemorating the deceased person in a virtual world using the Internet, which may be regarded as an “eternal” media.

The present invention provides the only social networking computerized system to combine memory and commemoration of the deceased within an online social network environment. The present invention allows a user to develop a memory of the deceased person from a personal perspective, derived of (or augmented with) experiences and content uploaded by living friends and relatives, combining live pictures and audio/video clips and other content items.

The system of the present invention further enables creating a commemoration page for deceased person(s) that are related to a specific event; such as, for deceased victim(s) of a terror attack, for deceased victim(s) of an earthquake or a hurricane or other force-of-nature or catastrophe (e.g., plane crash, train crash, vehicular crash), or the like.

The present invention provides to all users the computerized tools to create, modify and manage the memory and commemoration of their dearly departed friends or relatives, using a single web interface, or using multiple ways (e.g., a website; a dedicate application or “app” for a smartphone). The system may thus serve as a tool for managing a person's memory and commemoration online. The system may allow all members of the commemoration network to upload pictures and clips of the deceased at various stages of his/her life.

The platform of the present invention further enables a crowd-sourced process for collecting and uploading of pictures, documents, video and recordings for the deceased, to be used as part of the deceased person's online profile, and to be available to the public or to selected group(s) of users from the public.

The present invention further enables the transformation of a personal profile into a commemoration web-page using an automatic process or tool. For example, a living user Adam may have an active profile on a social network; later, Adam may pass away; his widow Jane or his son Bob may initiate a semi-automated process that converts the social network profile of Adam, into a social network commemoration profile (or page) in the social network of the present invention, using an automated or semi-automated tool or computerized process; for example, by “exporting” data (all data, or selected portions of the data) from the conventional social networking site, an “importing” such data to the unique social networking platform of the present invention which focuses on deceased persons.

The system may further allow users to pinpoint the burial site of a deceased persons on a map within the system, preventing the need for searching for a specific burial site of a particular deceased person; and making this burial information and map linked to, or part of, the commemoration page (or profile) of the deceased person.

The present invention enables and includes a search engine or search function, for historical information based on user content, images and clips relating to the deceased. For example, users may be able to search queries such as, “show me all photos of the deceased Adam Jones”, or “show me all users that like or follow the deceased Adam Jones”, or “show me all users that contributed any content to the commemoration profile of the deceased Adam Jones”, or other suitable queries or advanced search queries, with regard to the commemoration page or the commemoration profile related to the deceased person.

In some embodiments, the computerized system may utilize or identify multiple entities, for example: (a) Site member with a personal card or profile, containing the details of all of the friends of the deceased and other personal ties of the deceased (e.g., friends, family members, relatives, co-workers, colleagues). (b) The commemoration page (or profile) created for the deceased: Users may “follow” or “like” this page, or may be involved in the commemoration process, while uploading and sharing information or data items about the deceased: memories, photos, recordings and audio/video clips, as well as writing on a virtual “wall” of commemoration, and performing other virtual activities related to the deceased.

The system may allow creating a profile for anyone who passed away; any site member may create one or more commemoration pages for any deceased person(s). In some implementations, optionally, a deceased person may have multiple commemoration pages, which may be created, modified and/or managed by multiple living persons; and such multiple commemoration pages may co-exist in parallel; or may be “merged” together into a unified commemoration page if some or all of the creators of those pages indicate their consent to such merger; optionally, the system may autonomously identify that two or more, separate, profiles or pages exist with regard to the same deceased person (e.g., based on his name, date-of-birth, place-of-birth, family members, duplicate images, or other data), and may automatically propose to the creators of such pages to agree to “merging” of such pages into a unified page.

In some implementations, the system may not limit the number of commemoration pages that may be created for a deceased person. In other implementations, a maximum number of commemoration pages per deceased person, may be used and enforced by the system, in order to unify information and to avoid redundancy or unnecessary duplication.

The system may allow anyone who wants to, to take part in the circle of grief and memory; and enables people to share memories with others who knew the deceased—family members and friends, co-workers, colleagues, neighbors, or the like. The system further enables the preservation of information from the life of the deceased; such as pictures, audio/video clips, documents, recordings, texts, and other types of information or content.

The system enables creation of a timeline for documenting events in the life of the family and friends. The system enables sharing of emotions, relieving the pain, missing the deceased in a supportive and empathetic environment with other living persons who are similarly interested in exchanging memories and/or emotions and/or content related to the deceased person.

The system enables the commemoration of the deceased on an eternal medium, which may exist for decades or even centuries by using the Internet or other suitable network or global communication network; without the need to rely on papers or tangible objects that may degrade or parish. The system enables the management of all people to be remembered and commemorated by using a unified interface (e.g., a website, and optionally an application or “app” for a smartphone or tablet).

In some embodiments, the system may comprise or may utilize, some or all of the following components or modules: Site registration module, for creating a personal card or profile; Personal card management module, for managing or editing personal details, personal photos; Joining module, for joining existing commemoration and memorial sites or pages; a search module allowing card owners the ability to determine which commemoration pages or sites he/she wishes to join or to “follow”; a module for uploading pictures and audio/video clips to an existing commemoration site, or to a newly-created commemoration site; a module for adding friends to the personal card, with or without obtaining approval of such friends; a module for receiving updates on friends' online activities, in relation to a particular deceased person, or in relation to multiple deceased persons; a module for documenting card owner online activities, and optionally, making such online activities of the card owner be available to other users or to selected users or to the general public; a module for creating and managing a commemoration site for the deceased; a module for commemoration site management, enabling to create, modify and/or manage the content on the commemoration page; a module for adding content, deleting content, editing content, approving or rejecting content that was uploaded or suggested by other users, or the like; a module that allows the commemoration page creator to specify additional friends or persons as co-administrators of the commemoration site of the deceased person; a module for creating a timeline to document events in the family and among friends, including events which may be related to the deceased person's life (e.g., his birthday, or her wedding day) or to events occurring after his death (e.g., a yearly remembrance day on his date of death); a module for sending to other living users invitations to join the commemoration page; a module enabling any user of the general public to be part of the circle of grief and memorial, or in some implementations, selectively allowing only a selected group of people to be part of such circle, by allowing such users to view content and/or add content and/or modify content, optionally subject to the approval of the page creator; a module for sharing memories, information and/or content items with other living users who knew the deceased; a module allowing users to share or upload information about the life of the deceased (e.g., photos, audio/video clips, documents, recordings, texts); a module for selectively allowing or authorizing one or more of the above-mentioned functions, to all users, or to the general public, or only to a selected group of pre-approved living users; a module for commemoration site search, including advance search queries, and optionally using tagging of photos, audio/video clips, texts, and other content items; a module allowing personal card search capabilities; a module providing burial site location information, and map of the gravesite, with optional directions to the gravesite; a module enabling search capabilities based on user content, text, pictures and videos uploaded to various commemoration sties at any possible segmentation, for example, by years, events, location, names, or the like; a module for creating and maintaining a large database of information and classifying all (or most) of the deceased people around the world, or in a particular country or state or town; a module for online chat and dialogue among living site members, with regard to (or in relation to) a particular deceased; a module for online memorial “virtual candle lighting”, and online tools to donate to charity or to other goals in memory of the deceased person; a module to update and display a counter of the number of commemoration candles lit for the deceased; a module for creating a commemoration event and relating it to a personal commemoration card; a module for uploading pictures and posts (or other content items) related to a deceased person, segmented by years; and/or other suitable modules.

Some portions of the discussion herein may relate, for demonstrative purposes, to commemorating of a beloved person. However, the system of the present invention may be used for commemorating other types of person, such as a person that was known to a living user but was not necessarily beloved by the living user; and even, in some cases, to commemorate a person or a public figure which was controversial or was not beloved, for the sake of preserving the past history of such deceased person.

Some portions of the discussion herein may relate, for demonstrative purposes, to commemorating of a beloved human being that passed away; however, a system in accordance with the present invention may be used to commemorate other entities or creatures, for example, a deceased pet or animal, a corporation or company that went bankrupt or ceased to exist, a consumer product that is not marketed anymore and ceased to exist, or the like.

The present invention may be implemented, for example, by using a computer server or a web-server, which may include, for example: a processor, a memory unit, a storage unit, an input unit (e.g., keyboard, mouse), an output unit (e.g., screen, monitor, speakers), a wireless transceiver able to send and receive wireless communication signals, a Network Interface Card (NIC) or other network adapter, or the like. The system may utilize a database to store records which may reflect the data of deceased persons, the data of living members, the uploaded or created content items, the social networking activities performed, or the like.

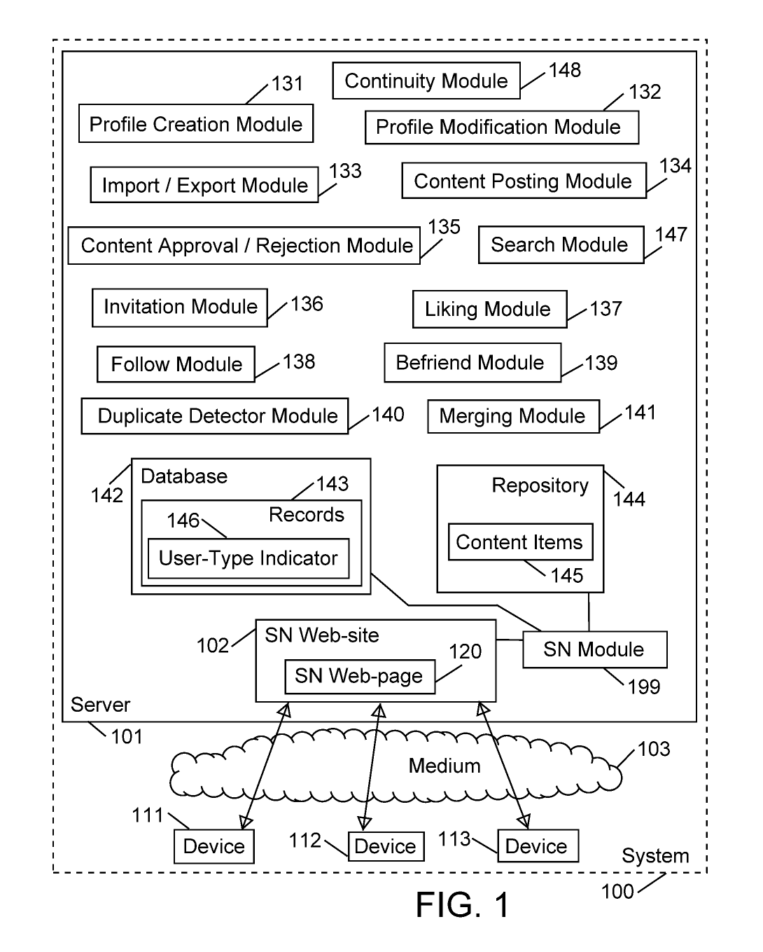

Reference is made to FIG. 1, which is a schematic block diagram illustration of a system 100, in accordance with some demonstrative embodiments of the present invention. System 100 may comprise, for example, a server 101 able to generate and serve web-pages of a social networking (SN) website 102, which may be accessed over a shared access medium 103 (e.g., the Internet, the World Wide Web, one or more communication networks) by one or more end-user devices, for example, devices 111-113 (e.g., a personal computer, a laptop computer, a tablet, a smartphone, or the like). The social networking website 102 may be, in accordance with the present invention, a social networking website in which some or all of the profiles of users are associated with deceased persons, and are being managed and/or created and/or updated by other, living, users of the social networking website.

In a demonstrative example, the user of device 111 may be regarded as “primary living user”, and may create a social networking web-page 120 for an already-deceased person. Then, the users of devices 112-113 (which may be regarded as “secondary living users”, namely, living users other than the creator of the web-page 120) may contribute and/or post and/or upload content items, which may be added to the web-page 120 of that already-deceased person.

In some implementations, the adding or modification of content items, by the secondary living users, may be subject to approval or pre-approval by the primary living users. In other implementations, the adding or modification of content items, by the secondary living users, may not require advance approval and/or post-priory approval by the primary living user. In other implementations, the adding or modification of content items, by the secondary living users, may not require advance approval and/or post-priory approval by the primary living users; but the primary living user may have post-priory privilege, to selectively discard or remove or delete or modify or “veto” content items that were submitted by the secondary living users (and were already posted on the web-page 120). In some embodiments, the primary living user may define or may configure, that a particular secondary user would be authorized to post content items to the web-page 120 without prior approval of the primary living user; whereas, another particular secondary user would be unauthorized to post content items to the web-page 120 without prior approval of the primary living user (and such submitted content items may be stored in a temporary queue for the inspection and approval/rejection by the primary living user, prior to being posted to the web-page 120).

In some embodiments, server 101 may comprise, for example: a profile creation module 131 allowing the primary living user to create a new web-page 120 for an already-deceased person; a profile modification module 132 allowing the primary living user to modify content of the web-page 120 for the already-deceased person; an import/export module 133, allowing the primary living user to import data and/or content items to web-page 120, from a web-page or a profile that belonged to the deceased person, and that resided (was stored) on another server or another website or another repository or another social networking platform.

In some embodiments, server 101 may comprise, for example: a content posting module 134, allowing users of devices 111-113 to post or submit or upload content items to web-page 120; an optional content approval/rejection module 135, allowing the primary living user to selectively approve (if such approval is required, according to the web-page 120 configuration) and/or to reject (and optionally, to modify and/or edit) content items that were submitted by the secondary living users.

In some embodiments, optionally, a secondary living user may be able to create a new web-page 121 of himself, on the social networking website 120; and may periodically post or add content items to his own web-page 121. Accordingly, in the social networking website 102, optionally, there may co-exist: (a) web-pages or profiles that are associated with deceased persons (e.g., web-page 120) and continue to be updated periodically by the primary living user and/or by secondary living users; and (b) web-pages or profiles that are associated with living persons (e.g., web-page 121) and are updated periodically by those living users.

In some embodiments, an invitation module 136 may allow the primary living user (or, a secondary living user) to invite other users of the social networking website 102, to visit the web-page 102 that is associated with the deceased person and that keep updating its content based on fresh content posted by living users. Optionally, a Liking module 137 may allow a living user of the social networking website 102, to “like” (to indicate that he likes) the web-page 120 of the deceased person; and a Like counter may be displayed on the web-page 120 and may be incremented and updated accordingly. Optionally, a Follow module 138 may allow a living user of the social networking website 102, to “follow” the web-page 120 of the deceased person; and a Following counter may be displayed on the web-page 120 and may be incremented and updated accordingly; and any new posts or updates on the web-page 120 (which is associated with the deceased person) may also be electronically sent to the user who “follows” that web-page 120 (e.g., via electronic mail, or text message, or through a dedicated “app” or application for mobile device). Optionally, a Befriend module 139 may allow a living user of the social networking website 102, to “befriend” the web-page 120 of the deceased person; and a Friends counter may be displayed on the web-page 120 and may be incremented and updated accordingly.

In some embodiments, a duplicate detector module 140 may scan and/or analyze the web-pages (such as web-page 120) of deceased persons on the social networking website 102; and may determine that two (or more) distinct web-pages 120 are actually associated with one-and-the-same deceased person. The detection may be based on, for example, the name (first name, last name, middle name, or any nickname) of the deceased person; date-of-birth of the deceased person; date of passing away of the deceased person; place of birth of the deceased person; place of passing away of the deceased person; particular family members and/or relations of the deceased person (e.g., parent name, sibling name, child name); identical or similar or partially-overlapping images or videos that were posted to the two (or more) distinct web-pages of the same deceased person; and/or other suitable data. Upon detection of two (or more) such distinct web-pages of the same deceased person, the duplicate detector module 140 may send messages to the creators of these web-pages, proposing to merge or unify the information on those web-pages into a unified single web-page (and eliminating the redundant duplicate page(s) that are not needed any more); and a merging module 141 may perform such merger of data upon approval of the creators of those web-pages.

System 100 may comprise a database 142 storing records 143 of data regarding the various users, pages, profiles and/or content items of the social networking website 102; and a repository 144 storing the actual content items 145 (e.g., images, video clips, audio clips). Each record may optionally comprise (or may point or link to, or may be associated with) a user-type indicator 146, indicating the type of user(s) that are associated with that record; for example, a first record may comprise data about the deceased person and may have a value of “deceased” as the user-type indicator 146; a second record may comprise data about the “primary living user” who created the web-page for that deceased person, and may have a value of “primary living user” as the user-type indicator; a third record may comprise data about another user or subscriber, who is not the deceased person and is not the “primary living user” that created the web-page, and such record may have other suitable of value user-type indicator, such as, for example, “secondary living user”, or “guest” or “visitor”, or the like. Other suitable types of fields or indicators may be used, to allocate roles to persons that interact with the social networking website 102 or to otherwise differentiate among their properties or characteristics.

A search module 147 may allow users to search the social networking website 102, by performing simple or Boolean or advanced search queries. In some embodiments, the search module 147 may allow users to search for profiles of deceased users; or to search for profiles of living users; or to search for profile of deceased users having certain attributes (e.g., based on name, based on place-of-birth, based on date-of-birth, based on place-of-death, based on date-of-death, based on family relations, or the like); or to perform advanced search queries (for example, “show me all living users that Liked the web-page of a particular deceased person”, or “show me the web-pages of all deceased persons who resided in a particular town”). Other search queries may be supported, including free-text search, field-based search, Boolean operators (“and”, “or”), other search operators (“near”), or the like. In some embodiments, search may be conducted based on an image or a video clip, for example, searching for a web-page of a particular deceased person based on an uploaded image or photograph of that deceased person.

In some embodiments, system 100 may optionally comprise a continuity module 148 responsible for ensuring that a web-page 120 or profile of a deceased person, on the social networking website 102, continues to be “kept alive” or kept functional and dynamically updated with new content items submitted (or posted) by living users; and ensuring that this web-page 120 of the deceased person is not mistakenly “frozen” or terminated or taken-offline or canceled; and ensuring that the content items of that web-page 120 of the deceased person remain available for consumption by living users; and ensuring that new content items may be submitted, uploaded and/or posted into the web-page of the already-deceased person currently-living users who may continue to submit or post or upload such content items; and to ensure that the web-page 120 of that deceased person is remaining fully-visible and fully-accessible and fully-operable by other users or members or subscribers of the social networking website 120 (e.g., including registered or logged-in visitors, and/or guest visitors who may not necessarily be logged-in or registered).

The present invention may provide an Internet-based or other network-based social network or virtual social network, directed towards commemoration and remembering of dead persons. The system may create and maintain digital assets for, or associated with, deceased persons; as well as for living persons that are interested in having their digital identity and digital presence preserved and maintained (and augmented and updated, by third parties, friends and relatives) after their subsequent death.

The social network may be accessed from various computing devices and/or electronic devices, portable and non-portable; and may receive or obtain or import content (e.g., images, videos, audio clips, text) from such devices.

In some embodiments, the system may comprise one or more modules or components, which may be aggregated together into a social networking module (SN module) 199, which is shown for demonstrative purposes as part of server 101; and which may be located or distributed over or across other device(s).

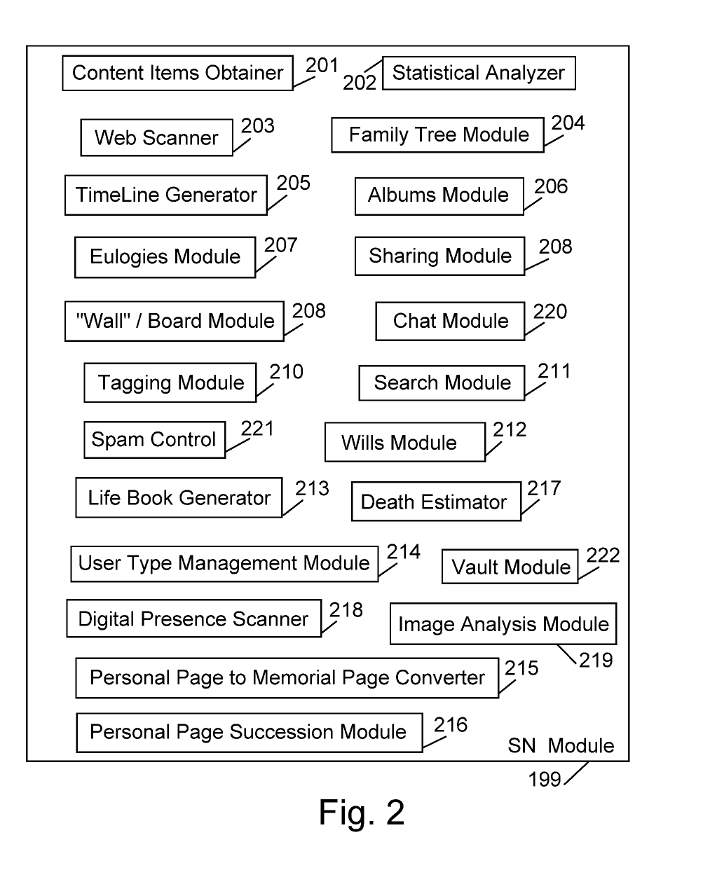

Reference is made to FIG. 2, which is a schematic block-diagram illustration of SN module 199, in accordance with some demonstrative embodiments of the present invention. SN module 199 may obtain, update, serve and/or manage information and data items, which may be obtained from end-user devices or from “cloud” resources or from “big data” resources or from other social networks or online content hubs; SN module 199 may comprise a content items obtainer module 201 for this purpose of obtaining such content items. Optionally, a statistical analyzer 202 may perform statistical analysis with regard to data submitted to the SN module 199 and/or data obtained by the SN module 199 from external sources, and may utilize such data in order to fine-tune the features or functions provided by SN module 199 to its users. Optionally, image recognition modules, face recognitions module, Optical Character Recognition (OCR) modules, audio processing modules, and/or video processing modules may be used; as well as a contextual analysis module able to analyze text(s) and deriving insights.

The SN module 199 may enable, for example, the following features or may utilize the following components or sub-modules: a user module, defining users and their levels of authorization; a personal Memorial Page; a “My Page” module allowing a living user to construct his own page; a Web Scanner module 203 able to scan or crawl or find digital/online presence of a person in other website or in other social networks or in other content hubs; a Family Tree module 204 to automatically construct a family tree representation; an automatic TimeLine generator 205 able to automatically generate a TimeLine of content items; an Albums module 206 able to manage, display, and update albums of content items; a Eulogies module 207 able to create, store and serve eulogies for deceased persons, including via text, audio, video, animation, or other multimedia formats; a sharing module 208 allowing users to share content with other users; a “wall”/board module 209 allowing users to leave comments or post articles or other content items to a virtual “wall” or “board” of messages; or the like.

Optionally, the SN module 199 may further include or comprise: a mailing module allowing emailing of messages or newsletters or user-to-user messages; an advertising module to show third-party advertisements or banners; a chat module 220 enabling textual chat, audio chat and/or video chat among two or more users of the social network; an integration module allowing the SN module 199 to share data with, to import data from, and/or to export data to other websites or content hubs or social networks; a tagging module 210 allowing manual and/or automatic tagging of images, videos, audio clips, and/or other content items; a search module 211 allowing to execute search queries with regard to any content in the social network; a “spam” (or “junk” content) control module 221 to block or remove or identify content that is regarded as “spam” or as malware; a digital safe module allowing a user to safely and securely store content items online (e.g., encrypted or password-protected); a developers interface allowing third-party developers to interact efficiently with the social network; a Wills Module 212 allowing a living user to create and/or update a Digital Will, in which the living user instructs what to do with its digital assets and/or his digital presence after his death, and in which a living user may allocate roles or requests towards other users with regard to the memorializing of such user after he passes away; a Life Book generator 213 able to automatically generate a book or album that describes and reflects a deceased person's life, with milestones and dates or years, and with content items corresponding to such milestones; or the like; and able to generate such book for downloading as a digital file, for further editing, and for sending to a professional print-shop for printing and binding and shipping; such Life Book comprising content items that were contributed and/or content items from the relevant TimeLine, and optionally comprising a family tree structure of the deceased. Optionally, the SN module 199 may communicate with one or more modules which may optionally be installed on an end-user device (e.g., a client-side module which may scan local content on the end-user device in order to export or upload images or videos or other content from the end-user device to the SN module 199).

A user may register to the system by filling-out a registration form, or by logging-in by utilizing user credentials from another social network or from another online account. A registered user may, for example: create and update Memorial Pages for other persons; create a personal memorial page for himself; open and view albums; export albums or content items from an end-user device (or from a “cloud” storage account) to the social network; import content items from third-party content hubs or from “cloud” storage to the social network; share pages or content items with other registered users and/or with third parties; request to automatically generate a family tree; command to automatically scan or crawl or search the Internet for additional content items for a particular memorial page or person; export a “contacts list” from an end-user device to the social network; define or configure privacy settings and/or authorization levels and/or access control, with regard to pages created by the user and/or with regard to content items uploaded by the user; tagging of content items, manually and/or automatically; joining an existing memorial page as a user that contributes content items to such existing memorial page; or the like.

In some embodiments, the SN module 199 may define and maintain three types of users with regard to a memorial page, via a User Type management module 214: (a) manager user, who created the memorial page; (b) member of the memorial page, who visited the memorial page and requested to “join” the memorial page as a member; and optionally, who was approved as a “member” by the manager user of that memorial page; (c) guest user or guest visitor, who is typically a registered user in the social network, but who did not request to be a “member” of a particular memorial page, and thus may have only partial or limited viewing rights with regard to that memorial page and/or its content. This module may create, manage and/or enforce such access-control authorizations or privileges.

A memorial page may comprise or may reflect, for example: name or title of the page, typically reflecting the name of the deceased person, or his nickname among friends; date of birth; date of death; place of birth; place of death; image(s) of the deceased person; a TimeLine of content items associated with the deceased; content worlds, sorted by years or year-ranges, and/or sorted by type of content (e.g., image albums, audio albums, video albums, textual albums); content sharing modules or widgets or buttons; spam reporting widget or button; a feed or a “wall” or board for posting content items and/or discussions; a Eulogies section for posting or displaying or consuming Eulogies created by one or more users; and/or other elements.

In some embodiments, the memorial page manager may create a new memorial page, by defining the name of the deceased person, his date of birth, and his date of death. The SN module 199 may automatically define or generate a timeline template which may automatically be configured to reflect the years (or range of years) in which the deceased person was alive. For example, if the memorial page manager defines that the deceased was born in 1970 and died in 2010, then the SN module 199 may automatically generate a Timeline having 41 slots corresponding to 41 years in which that person lived; or, a Timeline having 4 slots corresponding to 4 decades in his life. The Timeline may then be populated by the manager of the memorial page, by uploading content items from his device (or from third-party sources, or from “cloud” storage) to the SN module 199. Optionally, content analysis and/or face recognition may be performed on content items as they are uploaded or imported into the social network, in order to facilitate automatic tagging, automatic creation of family tree, automatic generation of albums, automatic placement of content items into specific years in the TimeLine, automatic grouping or sorting of content items into groups, or the like. In some embodiments, as a default, a memorial page may be publically-accessible, and may be submitted to search engines, and may appear in search results of general search engines.

A registered member of the social network may use an on-screen button or widget or link, to request to be added as a “friend” or member of a particular memorial page. Such addition may be automatic upon user request; or may be conditioned upon selective approval by the manager (creator) of that memorial page. A member of the memorial page may contribute content items, may post items onto a board or wall or “feed” of items, may create a Eulogy, may view content items that the page manager had defined as “for page members only”, or the like. A spam filter or spam detector module may scan submitted materials, in order to detect, recognize and/or prevent submission of spam messages or content, or to remove such spam content from the page; optionally using a pre-defined spam repository, spam detection rules and heuristics, or the like. Optionally, a statistical analysis module may monitor all interactions on the SN website and may deduce relations (e.g., friendship, family connection) among users based on interactions, submitted content items, tagging, names or usernames of users, and/or other data; and such deduced insights may be utilized for building or augmenting TimeLine content, family trees, or the like.

A living user may create his own personal page, comprising similar data items and content items; and optionally designating one or more heirs to that personal page. The living user may define whether he wishes that his personal page would be converted into a memorial page, upon his death; and a personal page to memorial page converter module 215 may perform such conversion automatically, if the user pre-defined his wish for such option. Adding, modifying and/or sharing content of personal page may be performed similarly to as described above with relation to a memorial page.

During the creation or editing of a personal page, the living owner of the page may designate one or more heirs to the page, through a mechanism handled by a personal page succession module 216. The system may generate different access codes, that may be provided to the personal page owner or directly to the heirs; with such access codes allowing such heir(s) to gain control over the personal page (e.g., upon the death of the original living owner). In some embodiments, the first heir to utilize his access code would become the sole administrator of the personal page of the deceased. In other embodiments, multiple heirs may receive administrator privileges with regard to the personal page of the deceased. In other embodiments, different privileges may be distributed to different heirs having different roles (e.g., a first heir allowed to upload new content; a second heir allowed to approve new content or to delete content). In other embodiments, if multiple heirs demand full administrator access rights to the page, the system may utilize pre-defined instructions that the page creator had placed before his death, in order to determine which one of the heirs would gain the control (e.g., based on order of priority or ranking, or based on age seniority, or based on other considerations that the page owner may pre-define).

In some embodiments, a death estimator module 217 may monitor the online interactions of a living user of the SN, and/or may detect prolonged inactivity of the page owner (e.g., longer than a pre-defined period of time, for example, one month), and/or may monitor interactions or content items posted or exchanged by other members of the SN (e.g., a user writing that “I am sad that my sister Jane Smith passed away yesterday”), in order to deduce or estimate that a user of the SN passed away. The death estimator module 217 may send one or more warning messages or questions, to the page owner (e.g., “you did not log-in for a long time; are you still around?”) and/or to friends of the page owner (e.g., “your friend Jane Smith did not log in for a long time; is she still alive?”), in order to actively find out or confirm that the person is alive or dead. Optionally, such messages may include quick-response buttons or links, allowing the receiver to easily convey feedback to the system. Upon determination that the user of a personal page passed away, the system may automatically convert the personal page of the user to a memorial page for that user; and may trigger the mechanism that designates one or more other users as heirs that would be authorized to control the newly-converted memorial page. Optionally, the system may distribute messages to friends of the deceased person, informing them that the person passed away recently and that his personal page was converted to a memorial page; and optionally notifying them who are the heir(s) that may control the memorial page. In some embodiments, a personal page that is not converted into a memorial page, may be “locked” and/or archived, or may become a read-only page.

The family tree module 204 may generate and/or update family tree representations or graphs, based on data within the SN and/or data from third-party social networks or sources; based on data entered by users of the SN; based on analysis of names of users, based on analysis of biographical information of users (e.g., date of birth, place of birth), based on analysis of images or other content items, taking into account tags and tagging of content items (e.g., a photo tag “me and my sister”), based on analysis of contact list information on end-user devices (e.g., contact phone-number for “dad” indicates father-son or father-daughter relationship), and optionally taking into account the intensity or frequency of interactions among users (e.g., ranked on a scale of 0 to 10) as indicator to the level of relation between them. These parameters may be used in order to generate and/or update family tree structures.

A digital presence scanner 218 may scan multiple digital resources, social networks, search engines, content hubs, the World Wide Web, and other sources, and may collect and show to the user of the SN an entire collection of his digital footprints or presence, including text, photos, videos, audio clips, tagged items, or the like. The user may be shown a list of the results, with an option to mark or select which items to automatically import into his personal page on the SN of the present invention, and subsequently into his post-death memorial page. The digital presence scanner may further detect, automatically, to which year or decade each content item belongs; and the content item—if imported into the SN—would be automatically inserted into the relevant year or decade (or time range) in the TimeLine. This allows an automatic creation of a TimeLine of content items, imported by the system and pre-sorted chronologically by the system; and optionally determining and/or indicating relations among content items (or among users), and optionally identifying friendship among users in each year or decade or time-range. The data collection process may utilize spiders and crawlers, may utilize image recognition and face recognitions, textual analysis and/or contextual analysis, tag-based analysis, and/or other parameters; and the collected data may further be used to construct and/or update family tree structures. The collected data items may be shown to the user for his selective confirmation which content items to import to the SN, and whether to include such content items within albums, within the TimeLine, or other suitable places. The TimeLine generator 205 may automatically generate such pre-sorted TimeLine of content items, based on the scanned and collected content items. Collection of content items and analysis of content items, from multiple sources or arenas or content hubs, may contribute to the enrichment of the TimeLine as well as family tree structures. Furthermore, tagging and content items submission by a first user, may automatically affect and enrich the TimeLine and/or the family tree structure of a second user (for example, if the first user tags a photo with “me and my sister Jane Smith”).

Images in the SN may be placed in different albums, and may be scanned or may be subject to face recognition by the system. For example, an image analysis module 219 may detect familiar or similar faces across images, to establish or deduce friendship relations or family connections among members; optionally taking into account tagging information of such images. In some embodiments, a single image that includes multiple persons, may affect the TimeLine or albums of multiple users that are determined to appear in that image. Analyzed images may be automatically tagged by the system, and such images may be placed on multiple TimeLines or in multiple photo albums corresponding to each one of the identified persons.

The Eulogies module 207 may allow to create a Eulogy, for example, a textual post that may be posted into a memorial page, indicating the author's name and date of authorship. The Eulogy module 219 may allow automatic analysis of created Eulogies, in order to determine connections among users (e.g., “I am sad that my sister Jane Smith passed away”), and to augment the data which describes relation or connection among users (e.g., for family tree structuring).

The system may allow sharing of content items, memorial pages, personal pages, and/or other items; including sharing within the SN, as well as sharing with external websites or applications or content hubs. The sharing module may allow a user to “publish” a content item or a page, that the user created and/or consumed, to one or more selected users or recipients. The system may monitor the sharing interactions, in order to deduce insights about relation or connection among user (e.g., identifying intensified or frequent sharing of content items among two particular users, and deducing that they are close friends or close relatives).

The system may allow user to write or post items onto a “wall” or “board”, allowing interactions among users. The interactions on such “wall” or “board” may be monitored in order to further augment the data about relations among users. A tailored advertising module may be utilized to provide and display tailored ads, to different users, based on their interactions and based on the content of such “wall” or “board”. The advertising module may take into account, for example, biographical data about the current user that views the page (e.g., taken from his personal profile when he is logged-in), his geo-location, gender, age, areas of interest, or the like. The advertising module may be augmented with data collected from hand-held devices and other end-user devices (e.g., running the application which operates with the SN of the present invention), to further tailor the ad content to the user and his interests.

The system may interface with third-party websites or social networks or content hubs or “cloud” repositories, in order to import content items and/or data from such sources. The imported data may be tagged, cataloged, sorted and/or placed in the suitable container or department on the SN (e.g., in the TimeLine, in photo albums, in family tree), and may further be analyzed to deduce insights about family relationships, about friendship among users, or the like.

The chat module 220 may enable online chat among users. Chat interactions may be monitored by the system, in order to deduce insights about relationship or friendship among users. The chat module 220 may utilize contact lists from hand-held devices or other end-user devices. The chat module 220 may optionally enable interactions between a user of the SN, and persons that are not users of the SN (for example, by sending a text SMS message or an email message from the SN system to such non-member person).

The spam control module 221 may operate on multiple layers or levels, for example: registration to the SN; posting of content items or content; use of chat; use of other messaging modules; reporting of abuse (by other users); geographical or regional control; and/or other levels of monitoring and/or intervention. The spam control module 221 may request authentication of email address and/or of personal identity. In response to abuse complaints, the spam control module may require the suspected user to perform one or more actions in order to prevent unlocking of his profile; for example, requiring a greater number of actions if the level of suspected spam is higher. In some embodiments, if a user is determined to be a spam source, then optionally, all the content that this user has contributed to the SN may be removed; and such removed content may be fed into the repository of the spam control module 221 in order to further teach the spam detection algorithm. In some embodiments, regional or geographical measures may be taken, for example, blocking suspicious activity that comes from a particular region, to not affect users in other geographical regions. The spam control module 221 may analyze text, images, videos, audio clips, and/or other data.

The tagging module 210 may tag content items (e.g., images, video, audio clips), optionally using contextual information and/or face recognition and/or image recognition algorithms, optionally using samples of audio and/or user-contributed data. A content item that is uploaded, may be automatically and/or manually tagged; and if determined to relate to other users (and if defined as Public items and not Private item), may be published to pages or TimeLines of other persons. The content items analysis may further detect relationship or friendship among users; and may further detect users emotion (e.g., based on contextual analysis of text, based on detecting smiles in photos or videos, based on detecting laughter or tone of speech in audio clips or in videos). The tagging module 210 may automatically tag images, based on face recognition; and the identified elements may be compared to spam repository, to family trees or family structures, to other content items that were uploaded by the same user and/or by other users, and/or to other content items that were imported from third-party sources or content hubs. The induced insights may be utilized to augment the determined relationships among users of the SN. Similarly, frames of video clips may be extracted and then analyzed, similar to the image analysis described above, and allowing tagging of video clips. Audio clips may be analyzed, firstly in order to detect and remove spam messages; and secondly in order to compare the audio clip to commercial or copyrighted materials that is available on third-party content hubs; thereby allowing the system to filter and maintain only original audio that reflects original music or sound or speech of the user.

The search module 211 may allow a user to search for personal pages and/or memorial pages; and the results may be sorted based on the level of connection between the searching user and each search result, based on a ranked list of connections of the searching user. The search terms and search queries may be monitored, in order to detect frequently-used queries or terms, which may be utilized for improving or fine-tuning the search results of subsequent queries or their rankings.

A vault module 222 may allow users to store files or content items in a secured and/or encrypted repository, which may be password protected and may require two-factor authentication for retrieval.

The Wills module 212 allows a user to create or upload a Will by text and/or video and/or audio, which may be digitally signed by the user and may be stored securely. The user may define one or more uses as trustees that will receive access to his Will after his death. The system may notify such users in advance that they are designated as trustees; and may provide access to them to the digital Will once the creating user is identified as deceased or is declared by other users as deceased.

The system may utilize a client-side agent module or client-side application or “app”, which may facilitate the collection and uploading of personal data and content items from an end-user device to the SN; and may assist in determining relationships among users (e.g., based on Contact List or Address Book data in such end-user devices). The agent module or “app” may allow the user to easily select which content items are to be uploaded from the end-user device to the SN; and the found items may be presented to the user sorted by years or based on their type in order to allow fast and easy selection. Optionally, the end-user device application may monitor the device for new content items, and may suggest to the user (e.g., periodically) that such new content items would be uploaded to the SN personal page. The client-side application may comprise one or more suitable modules or widgets or functions, for example, a “feed” of content items or updates from a “wall” or “board” of the SN, an albums module, a chat module, a search module, integration with the contact list or address book on the device, integration with GPS or geo-location sensor or data, a two-step authentication module, or the like.

Some embodiments of the present invention may include a computerized method comprising: (a) receiving a request of a primary living user to create a social networking web-page for an already-deceased person; (b) creating the social networking web-page for said already-deceased person; (c) authorizing said primary living user to upload content items to said social networking web-page of said already-deceased person, and receiving said content items uploaded by said primary living user; (d) presenting to other living users, the social networking web-page of said already-deceased person, comprising said content items uploaded by said primary living user.

In some embodiments, the method may further comprise: continuously receiving content items, uploaded by from one or more living users, to said social networking web-page of said already-deceased person; updating the social networking web-page of said already-deceased person to further include said content items uploaded by one or more living users.

In some embodiments, the method may further comprise: presenting to living users a non-static version of said social networking web-page of said already-deceased person in a non-static version; dynamically updating said social networking web-page of said already-deceased person based on content items that are posted by living users to said social networking web-page of said already-deceased person.

In some embodiments, the method may further comprise: receiving from a particular living user, a request for liking said social networking web-page of said already-deceased person; updating said social networking web-page of said already-deceased person to reflect an increase by one of the number of persons who liked said social networking web-page of said already-deceased person.

In some embodiments, the method may further comprise: receiving from a particular living user, a request for following said social networking web-page of said already-deceased person; updating said social networking web-page of said already-deceased person to reflect an increase by one of the number of persons who follow said social networking web-page of said already-deceased person; electronically sending updates to living users, who follow said social networking web-page of said already-deceased person, upon adding of a new content item to said social networking web-page of said already-deceased person.

In some embodiments, the method may further comprise: generating and presenting to said primary living user, an invitation interface to invite a particular living user to upload content items to said social networking web-page of said already-deceased person; upon a command from said primary living user, electronically sending an invitation to said particular living user to upload content items to said social networking web-page of said already-deceased person.

In some embodiments, the method may further comprise: receiving from said primary living user, a command to delete a content item included in said social networking web-page of said already-deceased person; in response to said command, received from said primary living user, deleting said content item which was included in said social networking web-page of said already-deceased person.

In some embodiments, the method may further comprise: receiving from said primary living user, a command to modify a content item included in said social networking web-page of said already-deceased person; in response to said command, received from said primary living user, modifying said content item which was included in said social networking web-page of said already-deceased person.

In some embodiments, the method may further comprise: creating on said social networking web-page of said already-deceased person, a list of content items, segmented into distinct years over a timeline, reflecting events related to said already-deceased person.

In some embodiments, the method may further comprise: adding to said timeline a content item corresponding to an event that occurred to said already-deceased person prior to the death of said already-deceased person.

In some embodiments, the method may further comprise: adding to said timeline a content item corresponding to an event that occurred subsequent to the death of said already-deceased person.

In some embodiments, the method may further comprise: authorizing to a secondary living user, to upload a new content item to said social networking web-page of said already-deceased person; presenting said new content item, to the primary living user, for approval or rejection; if the primary living user approves the new content item, then, adding the new content item to said social networking web-page of said already-deceased person; if the primary living user rejects the new content item, then, discarding the new content item without adding the new content item to said social networking web-page of said already-deceased person.

In some embodiments, the method may further comprise: authorizing to a secondary living user, to upload a new content item to said social networking web-page of said already-deceased person; automatically adding the new content item to said social networking web-page of said already-deceased person, without requiring approval of the primary living user.

In some embodiments, the method may further comprise: receiving from a particular living user, content items for a personal page of said particular living user; receiving from said particular living user, a user request that said personal page will automatically be converted into a memorial page after death of said particular living user; subsequently, determining that said particular living user is now deceased; automatically converting said personal page to memorial page associated with said particular person who is now deceased.

In some embodiments, the method may further comprise: receiving from a particular living user, content items for a personal page of said particular living user; receiving from said particular living user, a user request that said personal page will automatically be converted into a memorial page after death of said particular living user; subsequently, determining that said particular living user is now deceased; automatically converting said personal page to memorial page associated with said particular person who is now deceased; receiving from other users newly-submitted content items for said memorial page; adding said newly-submitted content items to said memorial page, subsequent to the death of said particular user.

In some embodiments, the method may further comprise: receiving from a particular living user, content items for a personal page of said particular living user; receiving from said particular living user, a designation of one or more successor users that will be authorized to control said personal page after the death of said particular living user; subsequently, determining that said particular living user is now deceased; notifying to said one or more successor users that they are now authorized to control said personal page since said particular living user died; authorizing only to said one or more successor users, to modify content of said personal page.

In some embodiments, the method may further comprise: receiving from a particular living user, content items for a personal page of said particular living user; monitoring online interactions of said particular living user; subsequently, estimating that said particular living user is now deceased, based on reduced frequency of online interactions of said particular living user; querying with one or more users, that are known to be friends or relatives of said particular living user, whether said particular living user is still alive; based on feedback from said one or more users, determining whether said particular living user is still alive or is now deceased.

In some embodiments, the method may further comprise: receiving from a particular living user, content items for a personal page of said particular living user; monitoring online interactions of said particular living user; subsequently, estimating that said particular living user is now deceased, based on lack of online interactions of said particular living user within a pre-defined time period; querying with one or more users, that are known to be friends or relatives of said particular living user, whether said particular living user is still alive; based on feedback from said one or more users, determining whether said particular living user is still alive or is now deceased.

In some embodiments, the method may further comprise: receiving from the primary living user, data describing at least: (a) a year of birth of said already-deceased person; (b) a year of death of said already-deceased person; (c) a name of said already-deceased person; and then: automatically generating a timeline representation for said already-deceased person, wherein the generated timeline representation begins in the year of birth of said already-deceased person, and wherein the generated timeline representation ends in the year of death of said already-deceased person; automatically dividing the generated timeline representation into multiple time intervals, each time interval spanning at least one year; automatically populating said generated timeline representation, with content items that are associated with said already-deceased person, wherein each content item is automatically placed into a time interval in the timeline representation that is relevant to said content item.

Some embodiments may be implemented using a specific-purpose machine or device, including at least one hardware component, or including at least one non-general-purpose hardware component; or including at least a dedicated or specific-purpose component or processor or sensor or other hardware element. Some embodiments may be implemented by using a non-general-purpose computer or a non-general-purpose computing platform.

Discussions herein utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Some embodiments of the present invention may take the form of an entirely hardware embodiment, an entirely software embodiment, or an embodiment including both hardware and software elements. Some embodiments of the present invention may be implemented in software, firmware, resident software, microcode, an application which may be downloaded and/or installed by a user, an application which may run in a browser, a client-side application, a server-side application, a client-server application, or the like. Some embodiments of the present invention may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system or device. Some embodiments of the present invention may be implemented, for example, using a machine-readable medium or article which may store an instruction or a set of instructions that, if executed by a machine, cause the machine (e.g., a computer or an electronic device) to perform a method and/or operations described herein.

Some embodiments of the present invention may include or may utilize, for example, a processor, a central processing unit (CPU), a digital signal processor (DSP), a controller, an integrated circuit (IC), a memory unit, a storage unit, input units, output units, wired and/or wireless communication units, an operating system, and other suitable hardware components and/or software modules.

Some embodiments may be implemented as, or by utilizing, an application or “app” for a Smartphone or tablet or portable computing device, which may be downloaded and/or installed onto such electronic device from an “app store” or an online marketplace for applications.

Functions, operations, components and/or features described herein with reference to one or more embodiments of the present invention, may be combined with, or may be utilized in combination with, one or more other functions, operations, components and/or features described herein with reference to one or more other embodiments of the present invention.

While certain features of the present invention have been illustrated and described herein, many modifications, substitutions, changes, and equivalents may occur to those skilled in the art. Accordingly, the claims are intended to cover all such modifications, substitutions, changes, and equivalents.

What is claimed is:

1. A computerized method comprising:
(a) receiving a request of a primary living user to create a social networking web-page for an already-deceased person;
(b) creating the social networking web-page for said already-deceased person;
(c) authorizing said primary living user to upload content items to said social networking web-page of said already-deceased person, and receiving said content items uploaded by said primary living user;
(d) presenting to other living users, the social networking web-page of said already-deceased person, comprising said content items uploaded by said primary living user.

2. The computerized method of claim 1, further comprising:
continuously receiving content items, uploaded by from one or more living users, to said social networking web-page of said already-deceased person;
updating the social networking web-page of said already-deceased person to further include said content items uploaded by one or more living users.

3. The computerized method of claim 1, further comprising:
presenting to living users a non-static version of said social networking web-page of said already-deceased person in a non-static version;
dynamically updating said social networking web-page of said already-deceased person based on content items that are posted by living users to said social networking web-page of said already-deceased person.

4. The computerized method of claim 1, further comprising:
receiving from a particular living user, a request for liking said social networking web-page of said already-deceased person;
updating said social networking web-page of said already-deceased person to reflect an increase by one of the number of persons who liked said social networking web-page of said already-deceased person.

5. The computerized method of claim 1, further comprising:
receiving from a particular living user, a request for following said social networking web-page of said already-deceased person;
updating said social networking web-page of said already-deceased person to reflect an increase by one of the number of persons who follow said social networking web-page of said already-deceased person;
electronically sending updates to living users, who follow said social networking web-page of said already-deceased person, upon adding of a new content item to said social networking web-page of said already-deceased person.

6. The computerized method of claim 1, further comprising:
generating and presenting to said primary living user, an invitation interface to invite a particular living user to upload content items to said social networking web-page of said already-deceased person;
upon a command from said primary living user, electronically sending an invitation to said particular living user to upload content items to said social networking web-page of said already-deceased person.

7. The computerized method of claim 1, further comprising:
receiving from said primary living user, a command to delete a content item included in said social networking web-page of said already-deceased person;
in response to said command, received from said primary living user, deleting said content item which was included in said social networking web-page of said already-deceased person.

8. The computerized method of claim 1, further comprising:
receiving from said primary living user, a command to modify a content item included in said social networking web-page of said already-deceased person;
in response to said command, received from said primary living user, modifying said content item which was included in said social networking web-page of said already-deceased person.

9. The computerized method of claim 1, further comprising:
creating on said social networking web-page of said already-deceased person, a list of content items, segmented into distinct years over a timeline, reflecting events related to said already-deceased person.

10. The computerized method of claim 1, further comprising:
adding to said timeline a content item corresponding to an event that occurred to said already-deceased person prior to the death of said already-deceased person.

11. The computerized method of claim 1, further comprising:
adding to said timeline a content item corresponding to an event that occurred subsequent to the death of said already-deceased person.

12. The computerized method of claim 1, further comprising:
authorizing to a secondary living user, to upload a new content item to said social networking web-page of said already-deceased person;
presenting said new content item, to the primary living user, for approval or rejection;
if the primary living user approves the new content item, then, adding the new content item to said social networking web-page of said already-deceased person;
if the primary living user rejects the new content item, then, discarding the new content item without adding the new content item to said social networking web-page of said already-deceased person.

13. The computerized method of claim 1, further comprising:
authorizing to a secondary living user, to upload a new content item to said social networking web-page of said already-deceased person;
automatically adding the new content item to said social networking web-page of said already-deceased person, without requiring approval of the primary living user.

14. The computerized method of claim 1, further comprising:
receiving from a particular living user, content items for a personal page of said particular living user;
receiving from said particular living user, a user request that said personal page will automatically be converted into a memorial page after death of said particular living user;
subsequently, determining that said particular living user is now deceased;
automatically converting said personal page to memorial page associated with said particular person who is now deceased.

15. The computerized method of claim 1, further comprising:
receiving from a particular living user, content items for a personal page of said particular living user;
receiving from said particular living user, a user request that said personal page will automatically be converted into a memorial page after death of said particular living user;
subsequently, determining that said particular living user is now deceased;
automatically converting said personal page to memorial page associated with said particular person who is now deceased;
receiving from other users newly-submitted content items for said memorial page;
adding said newly-submitted content items to said memorial page, subsequent to the death of said particular user.

16. The computerized method of claim 1, further comprising:
receiving from a particular living user, content items for a personal page of said particular living user;
receiving from said particular living user, a designation of one or more successor users that will be authorized to control said personal page after the death of said particular living user;
subsequently, determining that said particular living user is now deceased;
notifying to said one or more successor users that they are now authorized to control said personal page since said particular living user died;
authorizing only to said one or more successor users, to modify content of said personal page.

17. The computerized method of claim 1, further comprising:
receiving from a particular living user, content items for a personal page of said particular living user;
monitoring online interactions of said particular living user;
subsequently, estimating that said particular living user is now deceased, based on reduced frequency of online interactions of said particular living user;
querying with one or more users, that are known to be friends or relatives of said particular living user, whether said particular living user is still alive;
based on feedback from said one or more users, determining whether said particular living user is still alive or is now deceased.

18. The computerized method of claim 1, further comprising:
receiving from a particular living user, content items for a personal page of said particular living user;
monitoring online interactions of said particular living user;
subsequently, estimating that said particular living user is now deceased, based on lack of online interactions of said particular living user within a pre-defined time period;
querying with one or more users, that are known to be friends or relatives of said particular living user, whether said particular living user is still alive;
based on feedback from said one or more users, determining whether said particular living user is still alive or is now deceased.

19. The computerized method of claim 1, further comprising:
receiving from the primary living user, data describing at least: (a) a year of birth of said already-deceased person; (b) a year of death of said already-deceased person; (c) a name of said already-deceased person;
automatically generating a timeline representation for said already-deceased person, wherein the generated timeline representation begins in the year of birth of said already-deceased person, and wherein the generated timeline representation ends in the year of death of said already-deceased person;
automatically dividing the generated timeline representation into multiple time intervals, each time interval spanning at least one year;
automatically populating said generated timeline representation, with content items that are associated with said already-deceased person, wherein each content item is automatically placed into a time interval in the timeline representation that is relevant to said content item.
